(19) United States
(12) Patent Application Publication
(10) Pub. No.: US 2006/0109893 A1
(43) Pub. Date: May 25, 2006

(54) Inphase/quadrature phase imbalance compensation

(76) Inventors: Hsin-Hung Chen, Mountainside, NJ (US); Jiunn-Tsair Chen, Taipei (TW); Young-Kai Chen, Berkeley Heights, NJ (US); Po-Chiun Huang, HsinChu (TW); Kun-Yii Tu, Summit, NJ (US)

Correspondence Address: Lucent Technologies Inc.;Docket Administrator, Room 3J-219, 101 Crawfords Corner Road, Holmdel, NJ, 07733-3030, US

(21) Appl. No.: 10/998,122

(22) Filed: Nov. 24, 2004

(51) Int. Cl. H04L 5/16

(52) U.S. Cl. 375/219

(57) ABSTRACT

A transceiver includes a transmitter, a receiver, and an electrical feedback line. The transmitter has a quadrature-modulator and is configurable to compensate inphase/quadrature phase imbalances produced by hardware of the transmitter. The quadrature-modulator is configured to quadrature-modulate a carrier wave. The receiver has a quadrature-demodulator and is configurable to compensate for inphase/quadrature phase imbalances produced by hardware in the receiver. The quadrature-demodulator is configured to demodulate a quadrature-demodulated carrier. The electrical feedback line connects an output of the transmitter to an input of the receiver.

### BACKGROUND

1. Field of the Invention

The invention relates generally to quadrature-modulation and relates more particularly to methods and apparatus for compensating inphase/quadrature phase imbalance in transceivers.

2. Discussion of the Related Art

Some radio frequency (RF) transceivers provide direct or low intermediate frequency (IF) conversion architectures in which single-stage quadrature-modulation is available without bulky analog filters. In these architectures, the transceivers often produce imbalances between the parallel signal streams that are associated with inphase (I) and quadrature phase (Q) components of modulated carriers. These I/Q imbalances can include amplitude and/or phase mismatches of about one to three percent. Often, such I/Q imbalances result from errors related to the limited tolerance in the micro-fabrication of integrated circuits (ICs). Thus, I/Q imbalances cannot simply be eliminated from analog components of IC transceivers.

In an IC transceiver, digital signal processors (DSPs) can compensate I/Q imbalances that are produced by analog circuits of the transceiver. Indeed, DSP-assisted I/Q compensators outperform analog counterparts and are often easy to modify to enable circuit adaptation.

There are several types of DSP-assisted compensators for I/Q imbalance. One DSP-assisted I/Q compensator is configured to evaluate an I/Q imbalance via training cycles and then, exploit an adaptive algorithm to compensate for the I/Q imbalance. Another DSP-assisted I/Q compensator has adaptive filters that compensate for the I/Q imbalance in a low IF receiver.

DSP-assisted I/Q compensators may have several drawbacks. The possible drawbacks include the incorporation of significant extra circuitry to collect feedback information, a lack of compensation for imperfections in the calibration circuitry itself and/or a reliance on off-line training. Thus, it is desirable to have other methods and apparatus for compensating I/Q imbalances in quadrature-modulation transceivers.

### BRIEF SUMMARY

Various embodiments include transceivers that compensate I/Q transceiver imbalances by exploiting the duplex nature of the transceiver. The calibration of I/Q compensators involves coupling the output of the transmitter to the input of the receiver. The signal stream transmitted by the transmitter functions as a training stream for calibrating circuits for compensating hardware-induced I/Q imbalances. Thus, some of the new transceivers can calibrate I/Q compensation circuits without using off-line training cycles.

One embodiment features a transceiver that includes a transmitter, a receiver, and an electrical feedback line. The transmitter has a quadrature-modulator and is configurable to compensate inphase/quadrature phase imbalances produced by hardware of the transmitter. The quadrature-modulator is configured to quadrature-modulate a carrier wave. The receiver has a quadrature-demodulator and is configurable to compensate for inphase/quadrature phase imbalances produced by hardware in the receiver. The quadrature-demodulator is configured to demodulate a quadrature-demodulated carrier. The electrical feedback line connects an output of the transmitter to an input of the receiver.

Another embodiment features a method of reducing inphase/quadrature phase (I/Q) imbalances in a transceiver. The method includes updating a configuration of one or more I/Q compensators of the transceiver to reduce a roundtrip I/Q imbalance between parallel signal streams that the transceiver quadrature-modulates onto a carrier wave and then, demodulates from the carrier wave.

Another embodiment features a transceiver that includes a transmitter, a receiver, and an inphase/quadrature phase compensation controller. The transmitter has an inphase/quadrature phase digital compensator to produce, in parallel, first and second compensated digital signal streams from first and second input digital signals streams. The transmitter has an analog circuit for quadrature-modulating a carrier wave with said first and second compensated digital signal streams. The receiver has an analog circuit to produce, in parallel, first and second demodulated signal streams by demodulating a quadrature-modulated carrier. The receiver has an inphase/quadrature phase digital compensator to produce, in parallel, third and fourth compensated output digital signal streams from the first and second demodulated signals streams. The inphase/quadrature phase compensation controller is configured to determine inphase/quadrature phase mismatches for signals that are both quadrature-modulated by the transmitter and demodulated by the receiver.

### BRIEF DESCRIPTION OF THE DRAWINGS

FIG. 1 is a block diagram of a quadrature-modulation transceiver that implements dynamical compensation of inphase/quadrature phase (I/Q) hardware imbalances;

FIG. 2 is a timing diagram for one method of operating the transceiver of FIG. 1;

FIG. 3 is a block diagram showing analog (A) and digital (D) circuits in the transceiver shown in FIG. 1;

FIG. 4A is a block diagram of one embodiment of analog processing lines of the transmitter shown in FIG. 3;

FIG. 4B is a block diagram of one embodiment of analog processing lines of the receiver shown in FIG. 3;

FIG. 5A is a block diagram of one exemplary embodiment of the quadrature-modulator in the transmitter shown in FIG. 3;

FIG. 5B is a block diagram of one exemplary embodiment of the quadrature-demodulator in the receiver shown in FIG. 3;

FIG. 6A is a block diagram of one embodiment of an I/Q digital pre-compensator of the transmitter shown in FIG. 3;

FIG. 6B is a block diagram of one embodiment of an I/Q digital post-compensator of the receiver shown in FIG. 3;

FIGS. 7A and 7B illustrate the two modes of a 2×2 switch in the receiver of FIG. 3;

FIG. 8 is a flow chart illustrating a method of calibrating the I/Q pre-compensator and I/Q post-compensator of the transceiver shown in FIG. 3;

FIGS. 9A-9E show the evolution of I/Q gain imbalances as the method of FIG. 8 is performed for a first exemplary embodiment of the transceiver show in FIG. 3; and

FIG. 10 illustrates a simulation of the evolution of the I/Q compensating gains and phases as the method of FIG. 8 is performed for a second exemplary embodiment of the transceiver show in FIG. 3.

In the Figures and text, like reference numerals indicate elements with similar functions.

In the Figures and detailed description, various embodiments are described. Nevertheless, the inventions may be embodied in various forms and are not limited to the embodiments described in the Figures and detailed description.

### DETAILED DESCRIPTION OF ILLUSTRATIVE EMBODIMENTS

FIG. 1 shows a transceiver 10 that implements a quadrature-modulation scheme, e.g., quadrature phase shift keying or 16-phase shift keying with 4 and 16 signal-point constellations, respectively. The transceiver 10 includes a transmitter 12, a receiver 14, and an inphase/quadrature phase (I/Q) digital compensation controller 16.

The transmitter 12 converts V_{I,m} and V_{Q,m} digital baseband signal streams, which are received in parallel, into modulations on inphase and quadrature phase components of a carrier wave, e.g., an RF wave. The conversion includes processing the parallel signal streams in digital (D) and analog (A) circuits. Due to intrinsic limitations of micro-fabrication tolerances and/or variations in operating conditions, the A circuit typically introduces I/Q imbalances, i.e., amplitude and/or phase imbalances, between corresponding signals of the two parallel signal streams. The transmitter 12 outputs a quadrature-modulated carrier wave at an output, O, where a power amplifier 18 amplifies the modulated carrier prior to transmission to a channel, e.g., via transmission antenna 20.

The receiver 14 converts a quadrature-modulated carrier wave, which is received at input I into parallel V_{I,d} and V_{Q,d} digital baseband signal streams. The quadrature-modulated carrier is, e.g., received from reception antenna 22 via another low-noise amplifier 19 and a 2×1 switch 24. The conversion involves processing parallel signal streams, which are produced from the quadrature-modulated carrier, with both A and D circuits. Due to intrinsic limitations of micro-fabrication tolerances and/or variations in operating conditions, the A circuit typically introduces I/Q imbalances, i.e., amplitude and/or phase imbalances, between corresponding ones of the signals in the parallel signal streams.

The I/Q compensation controller 16 dynamically controls the transmitter 12 and receiver 14 with control signals transmitted via lines 26, 28. In particular, the I/Q compensation controller 16 calibrates DSPs, i.e., the D circuits, of both transmitter 12 and receiver 14 so that the DSPs compensate both amplitude and phase I/Q imbalances that are produced in the A circuit of each device. The I/Q compensation controller 16 dynamically adjusts the DSPs during calibration modes.

In each calibration mode, the 2×1 switch 24 connects electrical feedback line 30 between the output O of the transmitter 12 and the input I of the receiver 14 and disconnects the reception antenna 22 from the input I. In the calibration mode, the I/Q compensation controller 16 iteratively adjusts the DSPs so that V_{I,d}/V_{Q,d} equals V_{I,m}/V_{Q,m} in both magnitude and phase. The calibration mode may be incorporated into the standard duplex operation of the transceiver 10.

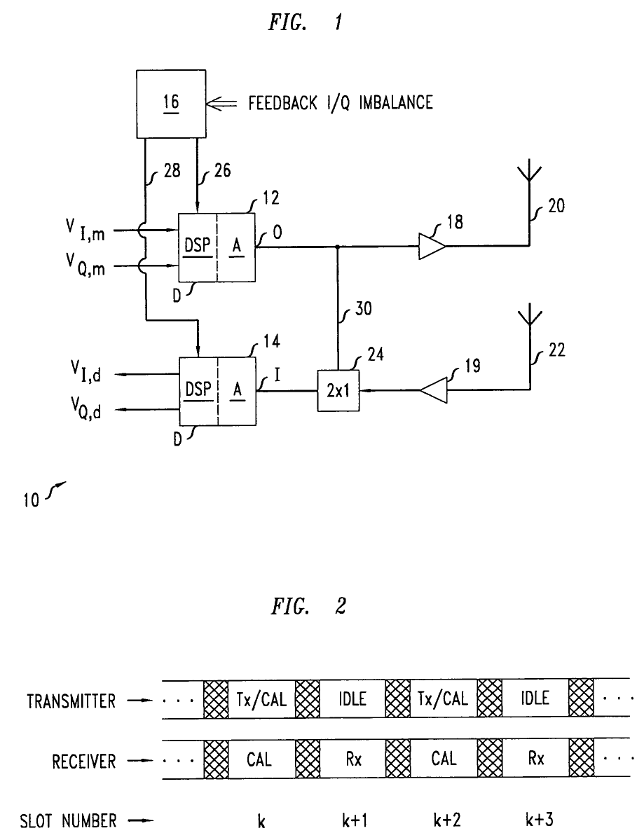

FIG. 2 illustrates one method for incorporating calibration (Cal) modes into the standard duplex operation, wherein the transceiver 10 interleaves reception time slots (Rx) and transmission time slots (Tx). During the Rx time slots, the transmitter 12 remains idle so that wireless transmissions of the transceiver 10 do not interfere with the reception of wireless transmissions from other transceivers (not shown). In the Tx time slots, the receiver 14 does not however, remain idle. Instead, the receiver 14 actively receives and processes the quadrature-modulated carrier transmitted in the Tx time slots. Indeed, this feedback quadrature-modulated carrier is used to calibrate the I/Q compensation circuits of the DSPs. The reception is preferably direct between the output O and input I to avoid nonlinear distortions in the amplifiers 18, 19. Comparing the known input signal streams, i.e., V_{Q,m} and V_{I,m}, to the two parallel signal streams, i.e., V_{Q,d} and V_{I,d}, produced by the receiver 14 enables determining whether I/Q compensation is needed. Thus, the Tx time slots serve both for transmission of communication to other transceivers and for calibration (Cal) of the digital I/Q compensation circuits of the transceiver 10 itself. For this reason, extra training cycles are not used to calibrate the circuits involved in compensating I/Q imbalances.

Whereas the A signal processing circuits of the transmitter 12 and receiver 12 generate I/Q imbalances, the I/Q compensation controller 16 dynamically calibrates digital pre- and post-compensation to eliminate overall I/Q imbalances in both transmitter 12 and receiver 14.

In the method of FIG. 2 and transceiver 10 of FIG. 1, calibration of I/Q compensation uses roundtrip pairs of signals, i.e., pairs of signals that are first quadrature-modulated in the transceiver's transmitter 12 and then, demodulated in the transceiver's receiver 14. For that reason, the calibration of the I/Q compensation is less susceptible to errors in circuitry that used to determine the I/Q imbalances.

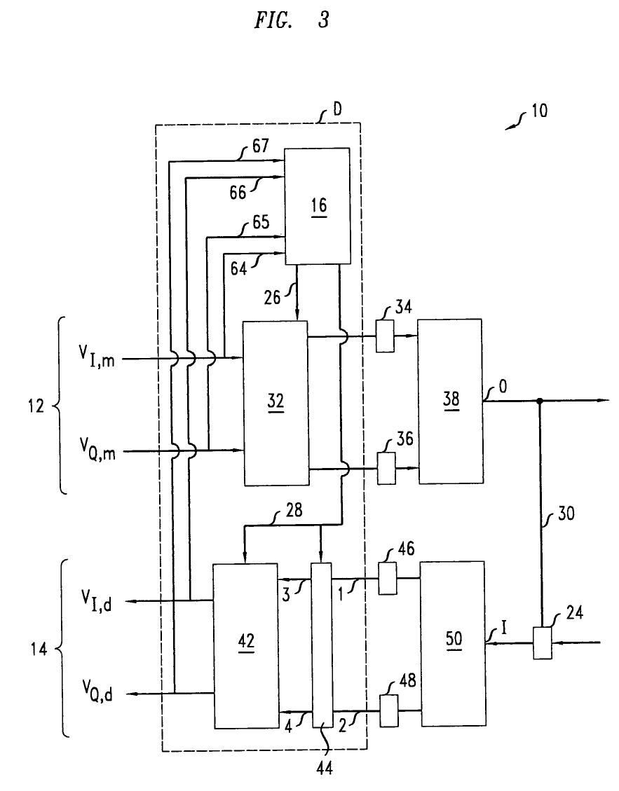

FIG. 3 shows portions of the D and A circuits of the transmitter 12 and receiver 14 of FIG. 1.

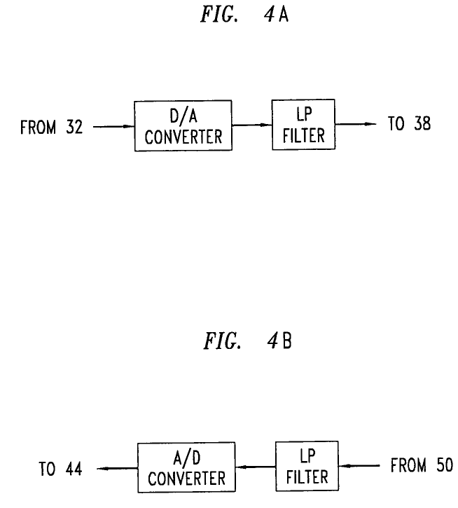

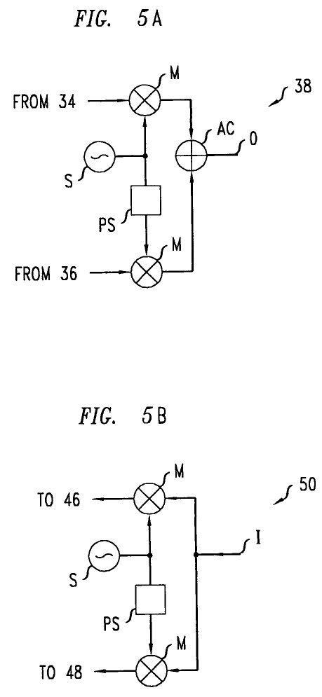

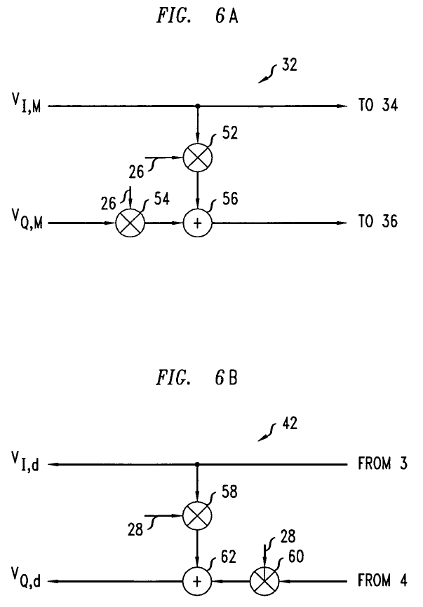

In the transmitter 12, the A circuit includes first analog processing line 34 for a first signal stream, parallel second analog processing line 36 for the parallel second signal stream, i.e., I and Q branches, and quadrature-modulator 38, and the D circuit includes digital I/Q pre-compensator 32. The first and second analog processing lines 34, 36 independently process the signal streams produced from the input V_{I,m} and V_{Q,m} digital baseband signal streams, respectively. Exemplary analog processing lines 34, 36 include a digital-to-analog (D/A) converter and a low pass (LP) filter as shown in FIG. 4A. The quadrature-modulator 38 mixes the I and Q components of a carrier wave with the processed signal streams received from the respective first and second processing lines 34, 36 to produce a quadrature-modulated carrier at output O. An exemplary quadrature-modulator 38 includes a source (S) for the carrier wave, a 90° phase shifter (PS), analog mixers (M's), and an analog combiner (AC) as shown in FIG. 5A. The digital I/Q pre-compensator 32 processes the input digital baseband signal streams V_{I,m} and V_{Q,m} to pre-compensate for I/Q imbalances that will be produced in the analog first and second processing lines 34, 36 and the analog quadrature-modulator 38.

In the receiver 12, the A circuit includes quadrature-demodulator 50, first analog processing line 46, and parallel second analog processing line 48, i.e., I and Q branches, and the D circuits includes 2×2 switch 44 and I/Q post-compensator 42. The quadrature-demodulator 50 mixes a received signal with a carrier wave to produce from the signal's I component and Q component two parallel signal streams at the baseband or at an intermediate frequency range. An exemplary quadrature-demodulator 50 includes a source (S) for the carrier wave, a 90° phase shifter (PS), and analog mixers (M's) as shown in FIG. 5B. The analog processing lines 46, 48 perform independent processing of the two parallel signal streams that are produced by the quadrature-demodulator 50. Exemplary analog processing lines 46, 48 include a LP filter, e.g., to recover the baseband, and an analog-to-digital (A/D) converter as shown in FIG. 4B. The I/Q digital post-compensator 42 processes the parallel baseband digital signal streams to dynamically compensate for I/Q imbalances, i.e., amplitude and/or phase imbalances generated in the processing lines 46, 48 and quadrature-demodulator 50. The 2×2 switch 44 enables controllably exchanging the two signal streams from the analog processing lines 46, 48 to provide for two connection modes, i.e., modes A and B.

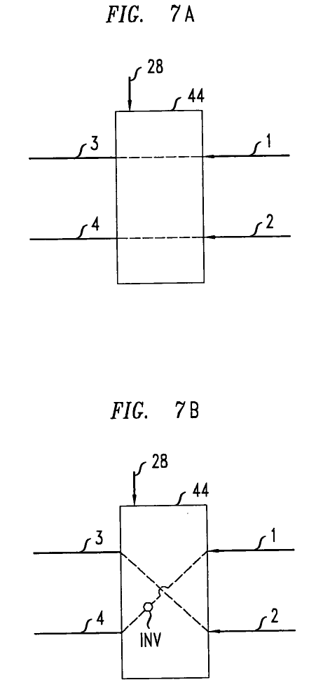

FIGS. 6A and 6B illustrate exemplary embodiments of the I/Q digital pre-compensator 32 and the I/Q digital post-compensator 42, respectively.

Referring to FIG. 6A, the I/Q pre-compensator 32 includes a digital multiplier 52; a digital multiplier 54, and a digital adder 56. The digital multiplier 52 has a controllable multiplier factor of tan(φ_{mc}) on one input, i.e., a gain factor, and the digital multiplier 54 has a controllable multiplier factor of 1/[g_{mc}cos(φ_{mc})] on one input, i.e., a gain factor. Here, g_{mc} and φ_{mc} are parameters are set dynamically and iteratively by the I/Q compensation controller 16 based on fed back gain ratios and phase differences for V_{Q,m} and V_{I,m} and for V_{Q,d} and V_{I,d}. The tan(φ_{mc}) and 1/[g_{mc}cos(φ_{mc})] gain factors of the digital multipliers 52, 54 are set by control signals received via line 26. The I/Q digital pre-compensator 32 compensates an A circuit of the transmitter 12 if the A circuit produces a gain imbalance of g_{mc} and a phase imbalance of φ_{mc} between the two parallel signal streams that quadrature-modulate the I and Q components of the carrier wave.

Referring to FIG. 6B, the I/Q post-compensator 42 includes a digital multiplier 58, a digital multiplier 60, and a digital adder 62. The digital multiplier 58 has a controllable multiplier factor of tan(φ_{dc}) on one input, i.e., a gain factor, and the digital multiplier 60 has a controllable multiplier factor of 1/[g_{dc}cos(φ_{dc})] on one input, i.e., a gain factor. Again, g_{dc} and φ_{dc} are parameters that are set dynamically and iteratively by the I/Q compensation controller 16 based on fed back gain ratios and phase differences for V_{Q,m} and V_{I,m} and for V_{Q,d} and V_{I,d}. The tan(φ_{dc}) and 1/[g_{dc}cos(φ_{dc})] gain factors of the digital multipliers 58, 60 are set by control signals received via line 28. The I/Q digital post-compensator 42 will compensate an A circuit of the receiver 14 if the A circuit produces a gain imbalance of g_{mc} and a phase imbalance of φ_{mc} between the two parallel signal streams made by quadrature-demodulating the I and Q components of a carrier wave.

Referring to FIGS. 7A-7B, the 2×2 switch 44 has inputs 1, 2 and outputs 3, 4. The switch 44 electrically connects the receiver's analog processing lines 46, 48 to the inputs of the I/Q post-compensator 42 in one of two modes. In mode A, the inputs 1, 2 connect to the outputs 3, 4 via the uncrossed configuration shown in FIG. 7A. In mode B, the inputs 1, 2 connect to the outputs 3, 4 via the crossed configuration show in FIG. 7B. In mode B, one of the connection lines of the switch 44 may include a digital inverter (INV). At the inputs of the I/Q post-compensator 42, such a single inverter INV will effectively cause an equivalent transformation of φ_{dc}→−φ_{dc}, wherein φ_{dc} is the phase parameter for the I/Q post-compensator 42. The switch 44 switches between the modes A and B in a manner that is responsive to control signals received via the line 28 from the I/Q compensation controller 16.

In other embodiments, the 2×2 digital switch 44 is replaced by an analog switch in the A circuit of the receiver 14. Then, the analog switch (not shown) would serially connect the input of the analog processing line 46 to one output the quadrature-demodulator 50 and would serially connect the input of the other analog processing line 48 to the other output of the quadrature-demodulator 50. Again, the crossed or B mode of such a switch typically could have an inverter on one of the internal lines of the switch.

Referring to FIGS. 1 and 3, the I/Q digital compensation controller 16 dynamically updates configurations of the I/Q pre-compensator 32 and the I/Q post-compensator 42 during calibration time slots, e.g., as shown in FIG. 2. Each update is based on a set of corresponding signal values from the V_{I,m}, V_{Q,m}, V_{I,d}, and V_{Q,d} digital signal streams. The sets of corresponding digital signal values are fed back to the I/Q digital compensation controller 16 via lines 64, 65, 66, 67. Herein, at cycle k, a corresponding set {V_{I,d}(k), V_{Q,d}(k), V_{I,m}(k), V_{Q,m}(k)} includes the input V_{I,m}(k) and V_{Q,m}(k) digital baseband signals for signal cycle “k” and the output V_{I,d}(k) and V_{Q,d}(k) digital baseband signals that are produced by demodulation in the receiver 14 of a carrier wave that was quadrature-modulated with the baseband V_{I,m}(k) and V_{Q,m}(k) signals. Performing this demodulation includes connecting the feedback line 30 between the output O of the transmitter 12 and the input I of the receiver 14 and setting the 2×2 switch 44 to mode A or B. That is, the signal set {V_{I,d}(k), V_{Q,d}(k), V_{I,m}(k), V_{Q,m}(k)} is associated with a roundtrip of a pair of signals through the transmitter 12 and receiver 14 of the same transceiver 10. From each such corresponding set of signals V_{I,d}(k), V_{Q,d}(k), V_{I,m}(k), and V_{Q,m}(k), the I/Q digital compensation controller 16 is configured to generate a corresponding amplitude and error signal, e_{g}(k), and a corresponding phase error signal, e_{φ}(k). Exemplary expressions for these error signals are:

$${e}_{g} ( k ) = \vert \frac{{V}_{I , m} ( k ) / {V}_{Q , m} ( k )}{{V}_{I , d} ( k ) / {V}_{Q , d} ( k )} \vert - 1$$

$${e}_{ϕ} ( k ) = arg \{ {V}_{I , m} ( k ) + ⅈ {V}_{Q , m} ( k ) \} - {sin}^{- 1} \{ \frac{{V}_{Q , d} ( k ) {V}_{I , m} ( k )}{{V}_{I , d} ( k ) \vert {V}_{I , m} ( k ) + ⅈ {V}_{Q , m} ( k ) \vert} \} .$$

From the corresponding error signals e_{g}(k) and e_{φ}(k), the I/Q digital compensation controller 16 is configured to generate an iterative update of the parameters g_{mc}(k), g_{dc}(k), φ_{mc}(k), and φ_{dc}(k) that define the processing properties of the I/Q pre-compensator 32 and the I/Q post-compensator 42 at cycle “k”. An update replaces the cycle-k parameter values g_{mc}(k), g_{dc}(k), φ_{mc}(k), and φ_{dc}(k) by updated cycle-(k+1) parameter values g_{mc}(k+1), g_{dc}(k+1), φ_{mc}(k+1), and φ_{dc}(k+1), respectively. An exemplary relationship between the updated and original parameters may, e.g., have the following form:
g_{mc}(k+1)=g_{mc}(k)[1+μ_{g}e_{g}(k)],
g_{dc}(k+1)=g_{dc}(k)[1+μ_{g}e_{g}(k)],
φ_{mc}(k+1)=φ_{mc}(k)+μ_{φ}e_{φ}(k), and
φ_{dc}(k+1)=φ_{dc}(k)+μ_{φ}e_{φ}(k).
Here, μ_{g} and μ_{φ} are step-sizes defining how the parameters g_{mc}(k), g_{dc}(k), φ_{mc}(k), and φ_{dc}(k) are incremented over a single update cycle. The above exemplary relationships provide an update operation that rescales g_{mc}(k) and g_{dc}(k) by an equal amount over a single update cycle and that shift φ_{mc}(k) and φ_{dc}(k) by an equal amount over a single update cycle. During calibration time slots, the I/Q compensation controller 16 iteratively updates the parameters for the I/Q pre-compensator 32 and the I/Q post-compensator 42 in a manner that reduces overall I/Q imbalances in both the transmitter 12 and the receiver 14.

In other embodiments of the transceiver 10, the e_{g}(k) and e_{φ}(k) error signals of the above update relations may be implemented to have other forms. For example, an one form for the phase error signal, e_{φ}(k), is given by:
e_{φ}(k)=[φ_{I,d}(k)−φ_{Q,d}(k)]−[φ_{I,m}(k)−φ_{Q,m}(k)].
Here, φ_{I,d}(k), φ_{Q,d}(k), φ_{I,m}(k), and φ_{Q,m}(k) are the phases of V_{I,d}(k), V_{Q,d}(k), V_{I,m}(k), and V_{Q,m}(k), respectively.

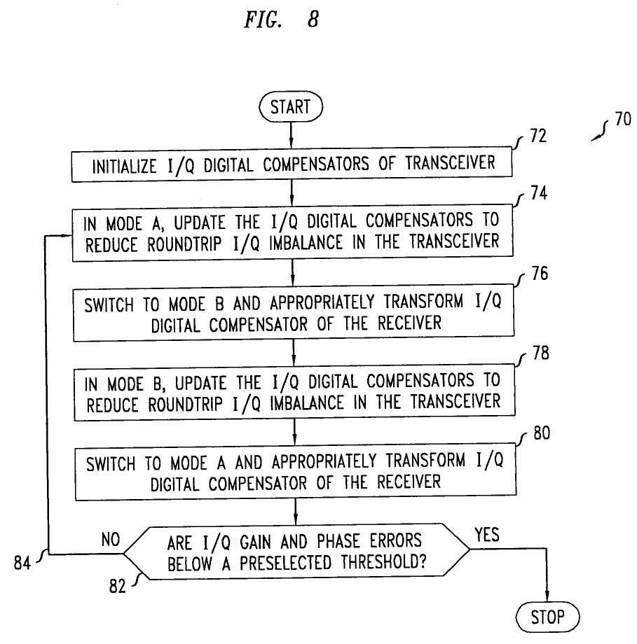

FIG. 8 illustrates one embodiment of a method 70 for calibrating the I/Q compensators 32, 42 of the transceiver 10 of FIGS. 1 and 3 so as to provide compensation of the I/Q imbalances in both the transmitter 12 and the receiver 14.

The method 70 includes initializing the parameters that define the properties of the I/Q digital compensators 32, 42 (step 72). Exemplary initial values satisfy: g_{mc}(k)=g_{dc}(k)=1 and φ_{mc}(0)=φ_{dc}(0)=0. Other initializations of these parameters are also possible in the method 70, which should be fairly insensitive to the specific initialization.

The method 70 includes performing a set iterative update cycles of the parameters defining the I/Q pre-compensator 32 and the I/Q post-compensator 42 while the switch 44 is kept in mode A (step 74). In each cycle k, the I/Q compensation controller 16 updates the parameters g_{mc}(k), g_{dc}(k), φ_{mc}(k), and φ_{dc}(k) as described in the above iterative update formulas. Each update involves rescaling g_{mc}(k) and g_{dc}(k) by equal multiplicative factors. Here, each multiplicative factor differs from one by a quantity proportional to the I/Q amplitude imbalance produced by a roundtrip of a signal pair through the transceiver 10. Each update also involves shifting φ_{mc}(k) and φ_{dc}(k) by the equal shift amounts. Here, each shift amount is, at least, roughly proportional to the I/Q phase imbalance produced by the roundtrip of signal pairs through the transceiver 10. The iterative updates stop either in response to the magnitudes of the e_{g}(k) and e_{φ}(k) error signals being smaller than a preselected threshold value or in response to a preselected number of said iterative updates having been performed.

Next, the method 70 includes switching the 2×2 switch 44 to mode B and appropriately transforming the parameters defining the I/Q digital post-compensator 42 (step 76). In particular, the switch to mode B interchanges the two parallel signal streams output by the receiver's A circuit. Thus, the switch effectively inverts the I/Q gain imbalance produced by said receiver's A circuit and changes the sign of the I/Q phase imbalance produced by said receiver's A circuit. At step 76, an appropriate transformation on the parameters that define the I/Q digital post-compensator 42 is:
g_{dc}(p)→[g_{dc}(p)]⁻¹ and φ_{dc}(p)→−φ_{dc}(p)
Here, p is the iterative update cycle number prior to the mode switch. Such a transformation enables the method 70 to effectively apply different updates to the I/Q compensator 32 and the I/Q compensator 42 in subsequent steps thereby enabling different I/Q compensations in the transmitter 12 and the receiver 14. Also, this transformation does not, e.g., change the overall I/Q balance of the transceiver 10 when it is performed along with the mode change if both the transmitter 12 and the receiver 14 are completely I/Q compensated.

Next, the method 70 includes performing a set iterative update cycles for the parameters defining the I/Q pre-compensator 32 and the I/Q post-compensator 42 while switch 44 is in mode B (step 78). In each cycle k, the I/Q compensation controller 16 again updates the present values of parameters g_{mc}(k), g_{dc}(k), φ_{mc}(k), and φ_{dc}(k) according to the above-described iterative update equations. In particular, each update involves rescaling g_{mc}(k) and g_{dc}(k) by equal multiplicative factors. Here, each factor differs from one by an amount proportional to the I/Q amplitude imbalance produced by a roundtrip of a signal pair through the transceiver 10. Similarly, each update involves shifting φ_{mc}(k) and φ_{dc}(k) by the equal amounts. Here, each shift amount is, at least, roughly proportional to the I/Q phase imbalance produced by a roundtrip of a signal pair through the transceiver 10. The iterative updates are stopped either in response to magnitudes of the e_{g}(k) and e_{φ}(k) error signals being smaller than a preselected threshold value or in response to having performed a preselected number of the iterative updates.

Next, the method 70 includes switching the 2×2 switch 44 back to mode A and appropriately transforming the parameters defining the I/Q post-compensator 42 (step 80). The switch of mode effectively inverts the I/Q gain imbalance produced by said A circuits and changes the sign of the I/Q phase imbalance produced by said A circuits. Here, the transformation is analogous to the transformation of step 76. Thus, the appropriate transformation of I/Q compensation parameters is again:
g_{dc}(p′)→[g_{dc}(p′)]⁻¹ and φ_{dc}(p′)→−φ_{dc}(p′).
Here, p′ is the iterative update cycle prior to the mode switch. Again, such a transformation does not change the overall I/Q balance of the transceiver 10 when it is performed along with the mode change if both the transmitter 12 and the receiver 14 are completely I/Q compensated.

Next, the method 70 includes evaluating whether the magnitudes of error signals e_{g}(k) and e_{φ}(k) are below another preselected threshold in mode A (step 82). If the magnitudes of the error signals are below the threshold, the calibrations of the I/Q digital pre-compensator 32 and the I/Q post-compensator 42 are completed. Otherwise, the method 70 may involve executing a loop 84 back to again perform steps 74-82.

### EXAMPLE 1

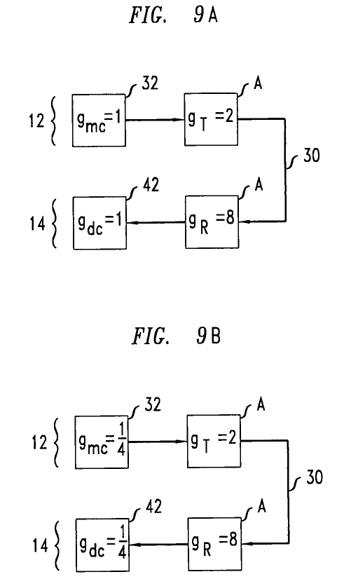

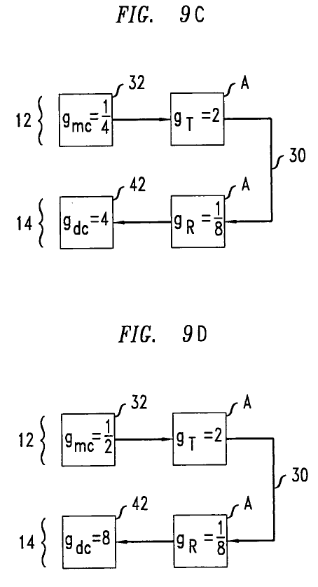

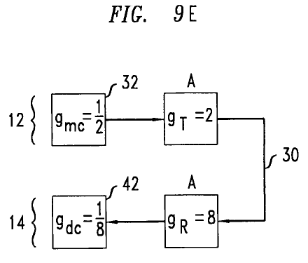

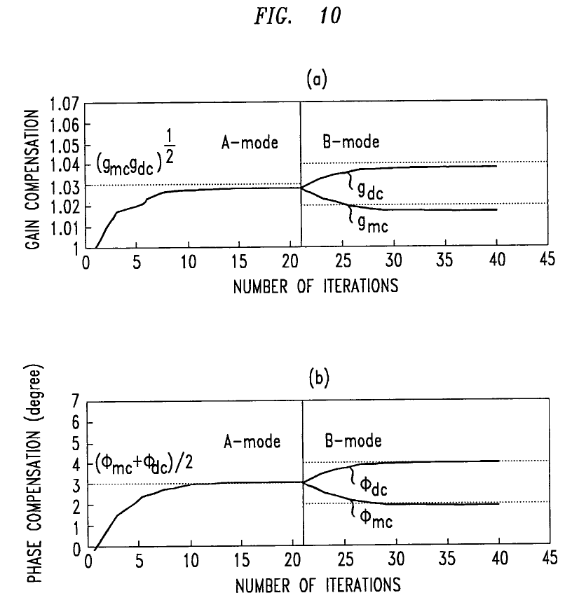

FIGS. 9A-9E illustrate the method 70 for an exemplary embodiment of transceiver 10. In the exemplary embodiment, the A circuit of the transmitter 12 has an I/Q imbalance that is a pure gain, g_{T}, wherein g_{T}=2. Similarly, in the exemplary embodiment, the A circuit of the receiver 14 has an I/Q imbalance that is a pure gain, g_{R}, wherein g_{R}=8. The method 70 evolves the gains g_{mc} and g_{dc} of the I/Q digital compensators 32, 42.

At step 72, the method 70 involves initializing the gain of both the I/Q pre-compensator 32 and the I/Q post-compensator 42 to one, i.e., g_{mc}(0)=g_{dc}(0)=1 as in FIG. 9A. Thus, the roundtrip I/P gain imbalance, g, i.e., g=|V_{I,m}(k)/V_{Q,d}(k)|/|V_{I,d}(k)/V_{Q,d}(k)|, initially satisfies: g=1×2×8×1=16.

At step 74, the method 70 involves iteratively rescaling the values of the gains of I/Q compensators 32, 42 while switch 44 is in mode A. The above-described iterative update formulas imply that each of the iterations will multiply the gain of both I/Q compensators 32, 42 by the same factor. The iterative rescalings stop after N iterations in response to e_{g}(N)≈0. Then, total roundtrip gain is one. This implies that g_{mc}(N)=g_{dc}(N)≈¼ as in FIG. 9B.

At step 76, the method 70 involves switching to mode B and appropriately transforming the gain of the I/Q post-compensator 42. Switching to mode B effectively inverts the gain of the receiver's A circuit from 8 to ⅛. Thus, the appropriate transformation of the gain, g_{dc}, of the I/Q post-compensator is the inversion transformation that maps g_{dc}(N) to [g_{dc}(N)]⁻¹=4 as in FIG. 9C.

At step 78, the method 70 involves performing additional M iterative updates of the gains of the I/Q pre-compensator 32 and the I/Q post-compensator 42, wherein the additional updates rescale the gains g_{mc} and g_{dc} by equal amounts and stop when e_{g}(N+M)≈0. Due to the condition on e_{g}(N+M), the updates stop when g_{mc}≈½ and g_{dc}≈8 as shown in FIG. 9D. Here, M is the number of additional iterations.

At step 80, the method 70 involves switching from mode B back to mode A and appropriately transforming the gain of the I/Q post-compensator 42. Switching to mode A returns the gain of the receiver's A circuit to 8, which implies that the appropriate transformation of the gain of the I/Q post-compensator 42 is: g_{dc}→[g_{dc}]⁻¹≈⅛ as shown in FIG. 9E.

At step 82, the method 70 involves evaluating the new value of the gain error e_{g}(N+M). After step 80, the new value of the gain error is zero. For that reason, the calibration of the I/Q compensators 32, 42 has been completed. The method 70 succeeded in completely compensating the I/P gain imbalances in both the transmitter 12 and the receiver 14.

### EXAMPLE 2

FIG. 10 shows a simulation of the evolution of the compensating I/Q gains and I/Q phases in another transceiver when these imbalances were corrected by the method 70 of FIG. 7. In the simulation, the A circuit of transmitter 12 has an initial I/P gain of 1.02 and an initial I/P phase of 2 degrees, and the A circuit of the receiver 14 has an initial I/P gain of 1.04 and an initial I/P phase of 4 degrees. The simulated results of FIG. 10 show that about 22 iterations in mode A and about 20 iterations in mode B suffice to compensate the I/P imbalances of both the transmitter 12 and receiver 14 for this exemplary embodiment. Thus, small I/Q imbalances can be rapidly dynamically compensated.

Other embodiments of the inventions will be apparent to those of skill in the art in light of the description, drawings and claims.

What is claimed is:

1. A transceiver, comprising:
a transmitter having a quadrature-modulator and being configurable to compensate inphase/quadrature phase imbalances produced by hardware of the transmitter, the quadrature-modulator being configured to quadrature-modulate a carrier wave;
a receiver having a quadrature-demodulator and being configurable to compensate for inphase/quadrature phase imbalances produced by hardware in the receiver, the quadrature-demodulator being configured to demodulate a quadrature-demodulated carrier; and
an electrical feedback line that connects an output of the transmitter to an input of the receiver.

2. The transceiver of claim 1, comprising an inphase/quadrature phase compensation controller being configured to adjust inphase/quadrature phase compensation in the receiver and the transmitter in response to the feedback line delivering a modulated carrier wave from the transmitter to the receiver.

3. The transceiver of claim 1, wherein one of the transmitter and the receiver includes a pair of analog processing lines and a switch, the analog lines being configured to process a parallel of signal streams in parallel and to perform one of receiving signals of said streams from the quadrature-demodulator and sending signals of said streams to the quadrature-modulator, the switch being capable of exchanging a connection of an end one of the lines with a connection of an end of the other of the lines.

4. The transceiver of claim 3, wherein the other of the transmitter and the receiver includes another pair of analog processing lines, the another pair of lines configured to process a pair of signal streams in parallel and to perform the other of receiving signals of said streams from the quadrature-demodulator and sending signals of said streams to the quadrature-modulator.

5. The transceiver of claim 1, further comprising an inphase/quadrature phase compensation controller configured to determine inphase/quadrature mismatches of signals quadrature-modulated by the transmitter and demodulated by the receiver.

6. The transceiver of claim 1, wherein the transmitter is configured to quadrature-modulate the carrier wave according to constellation having four signal points.

7. The transceiver of claim 1, wherein the transmitter is configured to quadrature-modulate the carrier wave according to constellation having more than four signal points.

8. The transceiver of claim 1, further comprising a nonlinear amplifier configured to amplify a quadrature-modulated carrier wave produced by the quadrature-modulator, the electrical feedback line being connected to receive a quadrature-modulated carrier wave without amplification by the amplifier.

9. A method of reducing inphase/quadrature phase (I/Q) imbalances in a transceiver, comprising:
updating a configuration of one or more I/Q compensators of the transceiver to reduce a roundtrip I/Q imbalance between parallel signal streams that the transceiver quadrature-modulates onto a carrier wave and then, demodulates from the carrier wave.

10. The method of claim 9, further comprising switching a mode of a transmitter or receiver of the transceiver to exchange parallel signal streams transmitted to or received from one of the I/Q compensators, and
then, again updating the configuration of the one or more I/Q compensators of the transceiver to reduce the roundtrip I/Q imbalance in signal streams that the transceiver quadrature-modulates onto a carrier wave and then, demodulates from the same carrier wave.

11. The method of claim 9, wherein the updating includes comparing I/Q mismatches between signals of two parallel streams received by the transmitter and corresponding signals of two parallel streams produced by the receiver.

12. The method of claim 10, wherein the again updating includes measuring I/Q mismatches between signals of parallel streams received by the transmitter and corresponding signals of parallel streams produced by the receiver.

13. The method of claim 10, wherein the again updating further comprises resetting an I/Q gain and/or a I/Q phase of an I/Q compensator to compensate an I/Q imbalance produced that the exchange of parallel signal streams.

14. A transceiver, comprising:
a transmitter having an inphase/quadrature phase digital compensator to produce, in parallel, first and second compensated digital signal streams from first and second input digital signals streams, the transmitter having an analog circuit for quadrature-modulating a carrier wave with said first and second compensated digital signal streams;
a receiver having an analog circuit to produce, in parallel, first and second demodulated signal streams by demodulating a quadrature-modulated carrier, the receiver having an inphase/quadrature phase digital compensator to produce, in parallel, third and fourth compensated digital signal streams from the first and second demodulated signals streams; and
an inphase/quadrature phase compensation controller configured to determine inphase/quadrature phase mismatches for signals that are both quadrature-modulated by the transmitter and demodulated by the receiver.

15. The transceiver of claim 14, wherein the compensation controller is configured to adjust inphase/quadrature phase compensation in the receiver and transmitter responsive the quadrature-modulated carrier wave from the transmitter being fed back to the receiver.

16. The transceiver of claim 14, wherein one of the transmitter and the receiver includes a switch capable of exchanging connections between first and second ports of one of the inphase/quadrature phase digital compensators and first and second ports of one of the analog circuits.

17. The transceiver of claim 15, wherein the transmitter is configured to quadrature-modulate the carrier wave according to constellation having four signal points.

18. The transceiver of claim 15, wherein the transmitter is configured to quadrature-modulate the carrier wave according to constellation having more than four signal points.
